(19) United States
(12) Patent Application Publication
(10) Pub. No.: US 2025/0391053 A1
(43) Pub. Date: Dec. 25, 2025

(54) PARAMETER CALIBRATION METHOD, ELECTRONIC DEVICE AND COMPUTER READABLE STORAGE MEDIUM

(71) Applicant: SUTENG INNOVATION TECHNOLOGY CO., LTD., Shenzhen (CN)

(72) Inventor: Jianrong LIANG, Shenzhen (CN)

(73) Assignee: SUTENG INNOVATION TECHNOLOGY CO., LTD., Shenzhen (CN)

(21) Appl. No.: 19/239,907

(22) Filed: Jun. 16, 2025

(30) Foreign Application Priority Data
Jun. 21, 2024 (CN) 202410815351.1

(51) Int. Cl. G06T 7/80; H04N 25/773

(52) U.S. Cl. CPC G06T 7/80; H04N 25/773

(57) ABSTRACT

A method, an electronic device, and a computer-readable storage medium are provided. The method includes: obtaining a calibration value of avalanche breakdown voltage of a single-photon avalanche diode array, calibration values of parameters of the single-photon avalanche diode array, and a temperature drift curve of the single-photon avalanche diode array; obtaining temperature of at least two positions of the single-photon avalanche diode array in a circumferential direction according to the calibration value; obtaining a temperature model of the single-photon avalanche diode array according to the temperature of at least two positions; and determining a calibration value of avalanche breakdown voltage of the single-photon avalanche diode array according to the temperature model, the temperature drift curve, and the calibration value of the parameter of the single-photon avalanche diode array and adjusting the input voltage of the single-photon avalanche diode array accordingly.

### CROSS-REFERENCE TO RELATED APPLICATION

The present application claims the benefit of priority to Chinese Patent Application No. 202410815351.1, filed on Jun. 21, 2024, which is hereby incorporated by reference in its entirety.

### TECHNICAL FIELD

The embodiments of the present application relate to the technical field of parameter calibration, and in particular to a parameter calibration method, an electronic device, and a computer-readable storage medium.

### BACKGROUND

Highly integrated single-photon avalanche diode (SPAD) arrays have the characteristics of high photon detection efficiency (PDE) and low dark count rate (DCR), and are the preferred photoelectric sensor devices in electronic devices. Among them, photon detection efficiency and dark count are the main performance parameters of SPAD arrays, which are related to the avalanche breakdown voltage of SPAD arrays.

However, during the operation of electronic devices, the heat generated by power devices will lead to temperature changes inside the device, resulting in uneven temperature distribution. The avalanche breakdown voltage of the SPAD array will change with the temperature, resulting in unstable SPAD array receiving parameters, which in turn leads to a decrease in the performance of the entire device.

### SUMMARY

The embodiments of the present application provide a parameter calibration method, an electronic device, and a computer-readable storage medium, which can realize real-time calibration of the avalanche breakdown voltage of a single-photon avalanche diode array, thereby improving the accuracy and stability of receiving parameters (such as DCR or PDE).

In a first aspect, an embodiment of the present application provides a parameter calibration method, which is applied to a single-photon avalanche diode array in an electronic device. The method includes: obtaining a calibration value of an avalanche breakdown voltage of the single-photon avalanche diode array, a calibration value of a parameter of the single-photon avalanche diode array, and a temperature drift curve of the single-photon avalanche diode array, where the parameters include dark counts and photon detection efficiency, and the temperature drift curve represents the corresponding relationship between the avalanche breakdown voltage of the single-photon avalanche diode array and the temperature of the single-photon avalanche diode array; according to the calibration value of the avalanche breakdown voltage of the single-photon avalanche diode array, values, obtaining the temperatures of at least two positions in the circumferential direction of the single-photon avalanche diode array; obtaining a temperature model of the single-photon avalanche diode array according to the temperatures of the at least two positions, where the temperature model represents the corresponding relationship between the temperature and the coordinates of the positions in the single-photon avalanche diode array; determining a calibration value of the avalanche breakdown voltage of the single-photon avalanche diode array according to the temperature model, the temperature drift curve and the calibration values of the parameters of the single-photon avalanche diode array; and adjusting the input voltage of the single-photon avalanche diode array according to the calibration value of the avalanche breakdown voltage of the single-photon avalanche diode array.

Through the above process, real-time calibration of the avalanche breakdown voltage of the single-photon avalanche diode array can be achieved, thereby improving the accuracy and stability of the receiving parameters.

In one or more embodiments, determining the calibration value of the avalanche breakdown voltage of the single-photon avalanche diode array according to the temperature model, the temperature drift curve and the calibration value of the parameter of the single-photon avalanche diode array includes: determining the current value of the avalanche breakdown voltage of the target area of the single-photon avalanche diode array according to the temperature model and the temperature drift curve; obtaining the current value of the parameter of the target area according to the current value of the avalanche breakdown voltage of the target area of the single-photon avalanche diode array; determining the calibration value of the avalanche breakdown voltage of the single-photon avalanche diode array according to the current value of the parameter of the target area and the calibration value of the parameter of the single-photon avalanche diode array.

Through the above process, it is possible to determine in real time whether the temperature generated during the operation of the electronic device has caused the avalanche breakdown voltage of the single-photon avalanche diode array to change, thereby causing fluctuations in the data of the received parameters, and it is possible to adjust the received parameters in time when the values of the received parameters fluctuate, so as to maintain the accuracy and stability of the received parameters.

In one or more embodiments, determining the current value of the avalanche breakdown voltage of the target area of the single-photon avalanche diode array according to the temperature model and the temperature drift curve includes: obtaining the temperature of the target position according to the temperature model and the coordinates of the target position, where the target position is located in the target area; obtaining the temperature of the target area according to the temperature of the target position; and determining the current value of the avalanche breakdown voltage of the target area according to the temperature drift curve and the temperature of the target area.

In one or more embodiments, determining the calibration value of the avalanche breakdown voltage of the single-photon avalanche diode array based on the current value of the parameter of the target area and the calibration value of the parameter of the single-photon avalanche diode array includes: determining the current value of the avalanche breakdown voltage of the target area as the calibration value of the avalanche breakdown voltage of the target area.

By configuring each area in the photon avalanche diode array as a target area in turn, the calibration values of the avalanche breakdown voltage of all areas in the photon avalanche diode array can be determined, and the calibration value of the avalanche breakdown voltage of the entire photon avalanche diode array can be determined, thereby realizing the calibration of the avalanche breakdown voltage of the single-photon avalanche diode array, which is beneficial to ensure the accuracy and stability of the avalanche breakdown voltage of the single-photon avalanche diode array.

In one or more embodiments, determining the calibration value of the avalanche breakdown voltage of the single-photon avalanche diode array based on the current value of the parameter of the target area and the calibration value of the parameter of the single-photon avalanche diode array includes: updating the target area, where the area of the updated target area is smaller than the area of the target area; and obtaining the temperature model based on the temperatures of the at least two positions.

Through the above process, the area of the target region can be reasonably configured to ensure that a relatively matched avalanche breakdown voltage can be input into the target region, thereby improving the accuracy of the receiving parameters of the target region.

In one or more embodiments, the target position includes at least two sampling points, and obtaining the temperature of the target area based on the temperature of the target position includes: calculating the average value of the temperatures of the at least two sampling points, and determining the average value of the temperatures of the at least two sampling points as the temperature of the target area.

By comprehensively analyzing the temperature measurement results of multiple sampling points, the impact of single-point failures can be reduced and reliability and stability can be improved.

In one or more embodiments, the coordinates of the position in the single-photon avalanche diode array are the coordinates in the coordinate system of the single-photon avalanche diode array, the X-axis extension direction of the coordinate system is the row direction of the single-photon avalanche diode array, the Y-axis extension direction of the coordinate system is the column direction of the single-photon avalanche diode array, the unit length of the coordinate system is the size of a single pixel of the single-photon avalanche diode array, and the origin of the coordinate system is the vertex of the single-photon avalanche diode array.

By establishing a coordinate system, it helps to accurately locate and describe the temperature at different locations, and can more intuitively display data and analyze temperature trends.

In one or more embodiments, the at least two positions are symmetrical about the axis of symmetry of the single-photon avalanche diode array.

The positions corresponding to the detected temperatures are configured to be symmetrical, which can provide a more comprehensive and accurate understanding of the temperature distribution of the entire single-photon avalanche diode array, reduce measurement errors, and improve measurement accuracy.

In a second aspect, an embodiment of the present application provides an electronic device, including: a single-photon avalanche diode array; a memory for storing executable program code; and a processor for calling and running the executable program code from the memory, so that the electronic device executes the parameter calibration method as described above.

In a third aspect, an embodiment of the present application provides a computer-readable storage medium, which stores a computer program. When the computer program is executed, the parameter calibration method as described above is implemented.

The beneficial effects of the present application are as follows: the parameter calibration method, electronic device, and computer-readable storage medium of the embodiments of the present application determine the temperature model of the single-photon avalanche diode array by measuring the temperature of at least two positions in the circumference of the single-photon avalanche diode array, and implement real-time calibration of the avalanche breakdown voltage of the single-photon avalanche diode array by using the temperature model, thereby ensuring the accuracy and stability of the receiving parameters of the single-photon avalanche diode array.

### BRIEF DESCRIPTION OF DRA WINGS

One or more embodiments are exemplarily described by figures in the corresponding drawings, and these exemplary descriptions are not intended to limit the embodiments. Elements with the same reference numerals in the drawings represent similar elements.

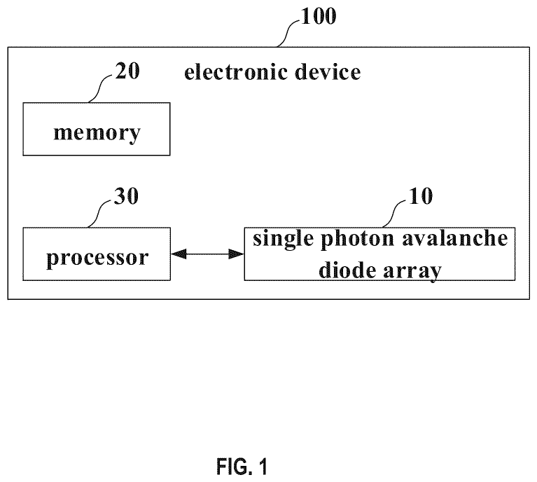

FIG. 1 is a schematic diagram of the structure of an electronic device provided in an embodiment of the present application;

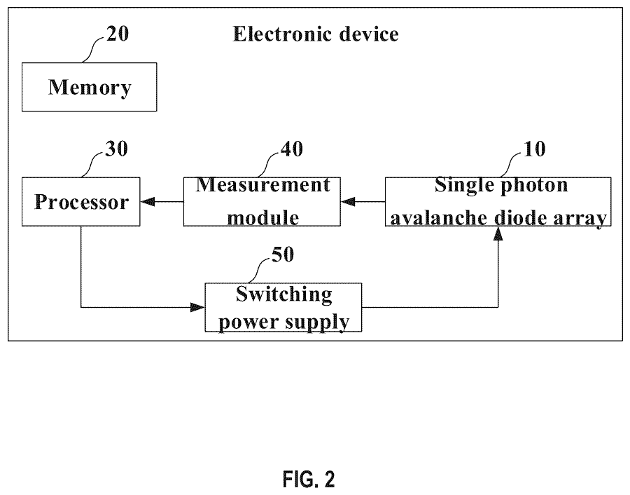

FIG. 2 is a schematic diagram of the structure of an electronic device provided in an embodiment of the present application;

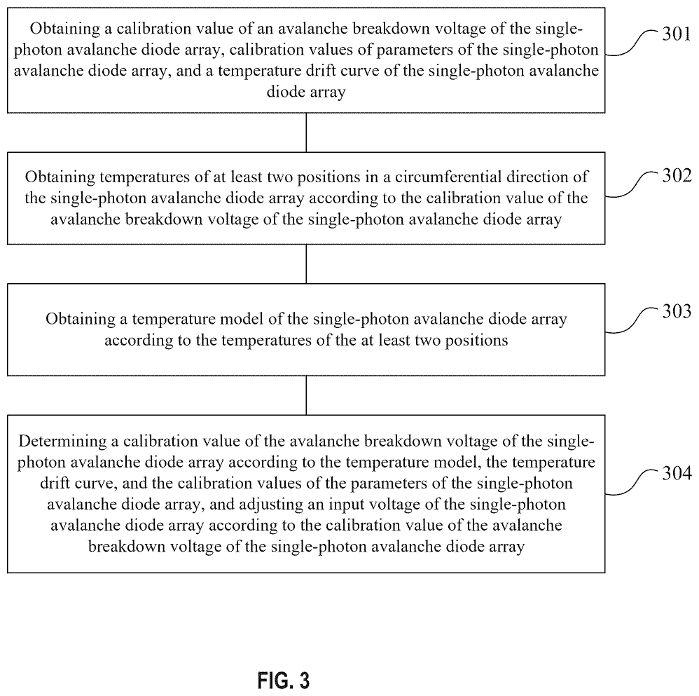

FIG. 3 is a flow chart of a parameter calibration method provided in an embodiment of the present application;

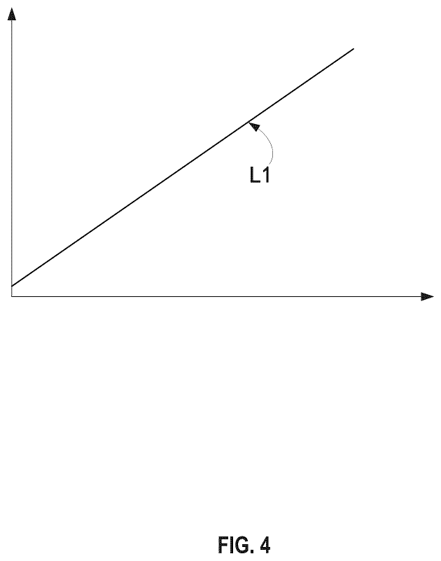

FIG. 4 is a schematic diagram of a temperature drift curve provided in an embodiment of the present application;

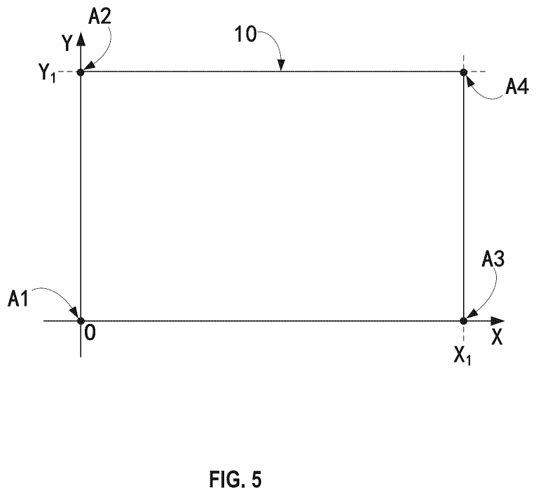

FIG. 5 is a coordinate system of a single-photon avalanche diode array provided in an embodiment of the present application;

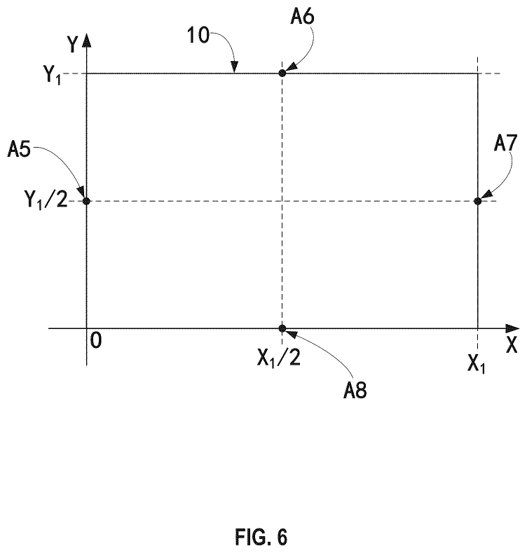

FIG. 6 is a coordinate system of a single-photon avalanche diode array provided in an embodiment of the present application;

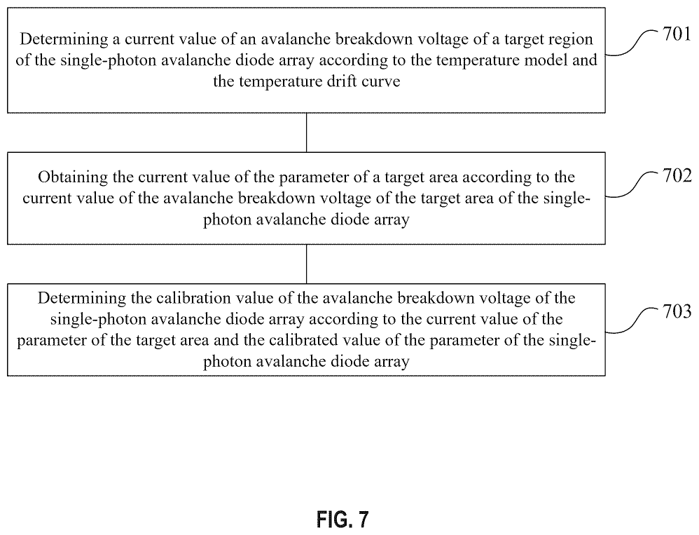

FIG. 7 is a schematic diagram of an embodiment of step 304 shown in FIG. 3;

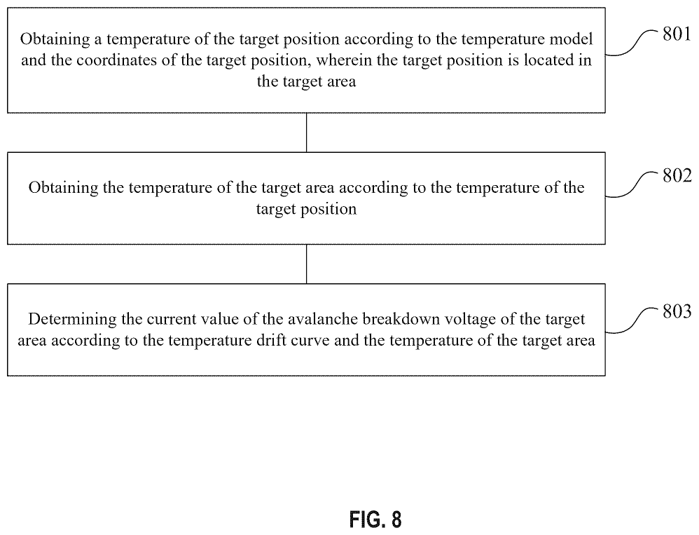

FIG. 8 is a schematic diagram of an embodiment of step 701 shown in FIG. 7;

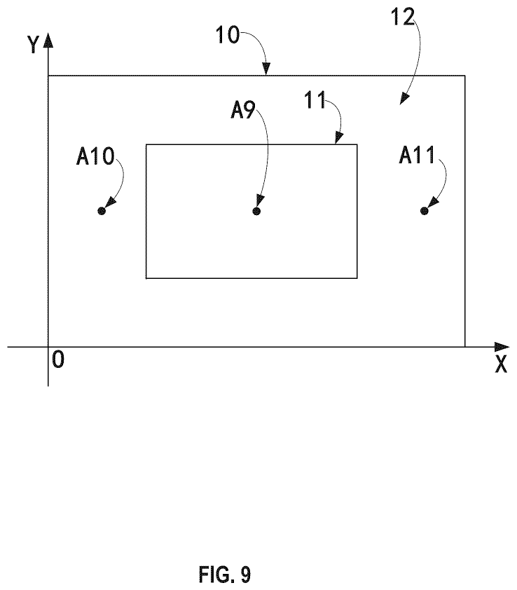

FIG. 9 is a coordinate system of a single-photon avalanche diode array provided in an embodiment of the present application; and

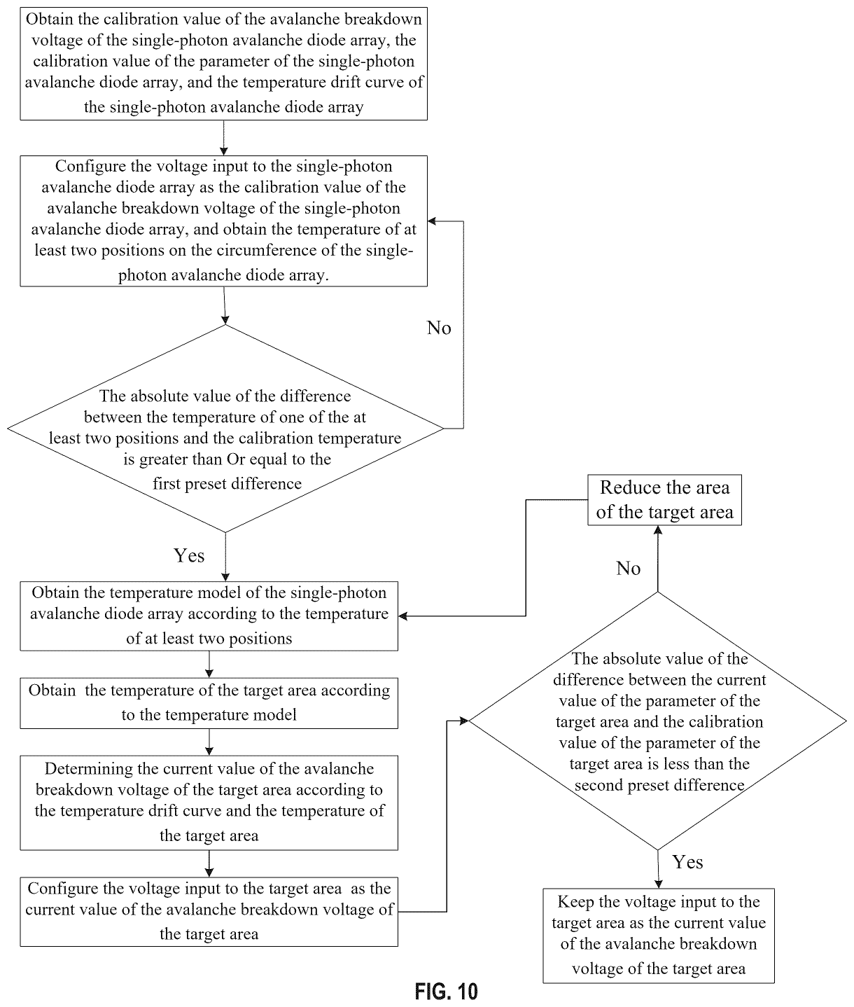

FIG. 10 is a flow chart of a parameter calibration method provided in an embodiment of the present application.

### REFERENCE NUMERALS

100, electronic device; 50, switching power supply; 40, measurement module; 30, processor; 20, memory; 12, edge area; 11, central area; 10, single-photon avalanche diode array; L1, temperature drift curve.

### DETAILED DESCRIPTION

In order to make the purpose, technical solution, and advantages of the present application clearer, the technical solution of the present application will be described in detail below in conjunction with the drawings. Obviously, the described embodiments are part of the embodiments of the present application, not all of the embodiments. It should be understood that the embodiments described here are only used to explain the present application and are not used to limit the present application.

It should be noted that when an element is described as being “connected to” another element, it may be directly connected to the other element, or one or more intervening elements may exist there between.

In addition, the technical features involved in the various embodiments of the present application described below can be combined with each other as long as there is no structural conflict between them.

Please refer to FIG. 1, which is a schematic diagram of the structure of an electronic device provided in an embodiment of the present application. As shown in FIG. 1, the electronic device 100 includes a single-photon avalanche diode array 10, a memory 20, and a processor 30.

The electronic device 100 may be a device that uses electronic technology and electronic components for operation and control, such as a LiDAR or a laser rangefinder. During the operation of the electronic device 100, such as when running an application, processing a large amount of data, or running a complex task, most of the power consumption will be dissipated in the form of heat energy, causing the temperature of the electronic device 100 to rise. The temperature changes of the electronic device 100 will cause the avalanche breakdown voltage of the single-photon avalanche diode array 10 to change, thereby causing the value fluctuation of the receiving parameter (such as DCR or PDE), and then causing the performance of the electronic device 100 to deteriorate. In some embodiments, the electronic device 100 is a LiDAR. When the LiDAR is used to detect the distance from the target object, as the LiDAR heats up, the temperature of the single-photon avalanche diode array 10 changes, and its avalanche breakdown voltage changes accordingly, causing the value fluctuation of the receiving parameter, which will cause the distance detected by the LiDAR to deviate from the actual distance.

The embodiment of the present application provides a parameter calibration method, which can calibrate the avalanche breakdown voltage of a single-photon avalanche diode array in real time during the operation of an electronic device to ensure the accuracy and stability of the received parameters. The implementation process of the method is described as follows.

The memory 20 is used to store executable program codes. The memory 20, as a non-volatile computer-readable storage medium, can be used to store non-volatile software programs, non-volatile computer executable programs, and modules. The memory 20 may include a program storage area and a data storage area, where the program storage area may store an operating system and at least one application required for a function. The data storage area may store data created according to the use of the terminal, etc. In addition, the memory 20 may include a high-speed random access memory, and may also include a non-volatile memory, such as at least one disk storage device, a flash memory device, or other non-volatile solid-state storage device. In some embodiments, the memory 20 may optionally include a memory remotely arranged relative to the processor 30, and these remote memories may be connected to the terminal via a network. Examples of the above-mentioned network include, but are not limited to, the Internet, an intranet, a local area network, a mobile communication network, or combinations thereof.

The processor 30 is used to call and run the executable program code from the memory, so that the electronic device 100 executes the parameter calibration method in any embodiment of the present application. The processor 30 executes various functions of the terminal and processes data by running or executing the software program and/or module stored in the memory 20, and calling the data stored in the memory 20, so as to monitor the terminal as a whole, for example, to implement the parameter calibration method in any embodiment of the present application. The processor 30 and the memory 20 can be connected through a bus or other means. The processor 30 may include a central processing unit (CPU), a digital signal processor (DSP), an application specific integrated circuit (ASIC), a controller, a field programmable gate array (FPGA) device, etc. The processor 30 can also be implemented as a combination of computing devices, for example, a combination of a DSP and a microprocessor, a plurality of microprocessors, one or more microprocessors combined with a DSP core, or any other such configuration.

In some embodiments, as shown in FIG. 2, the electronic device 100 further includes a measurement module 40 and a switching power supply 50.

The measurement module 40 is electrically connected between the single-photon avalanche diode array 10 and the processor 30. The measurement module 40 is used to obtain the photon pulse generated by the single-photon avalanche diode array 10 and determine the number of photons corresponding to the single-photon avalanche diode array 10. The single-photon avalanche diode array 10 is composed of a plurality of single-photon avalanche diodes, each of which can detect the arrival of a single-photon. When a photon hits the single-photon avalanche diode, it excites the carriers in the single-photon avalanche diode, which are accelerated under the action of the electric field. When the accelerated carriers reach the avalanche breakdown voltage, an avalanche effect is triggered and a measurable current pulse is generated, which corresponds to a photon pulse. Based on the photon pulse generated by each single-photon avalanche diode, the number of photons corresponding to each single-photon avalanche diode is determined. The number of photons corresponding to each single-photon avalanche diode in the single-photon avalanche diode array 10 is summed up to obtain the number of photons corresponding to the single-photon avalanche diode array 10 (recorded as the total number of photons).

In some embodiments, when the single-photon avalanche diode array 10 includes N single-photon avalanche diodes, the measurement module 40 includes N pulse acquisition units and N counting units, where Nis an integer greater than or equal to 2.

In one embodiment, the N single-photon avalanche diodes include a first single-photon avalanche diode, a second single-photon avalanche diode, . . . , an N^{th} single-photon avalanche diode. The N pulse acquisition units include a first pulse acquisition unit, a second pulse acquisition unit, . . . , an N^{th} pulse acquisition unit. Each of the N pulse acquisition units is connected to a single-photon avalanche diode in the single-photon avalanche diode array, for example, the first pulse acquisition unit is connected to the first single-photon avalanche diode. Each of the N pulse acquisition units is configured to acquire a photon pulse generated by the single-photon avalanche diode connected thereto, for example, the first pulse acquisition unit is configured to acquire a photon pulse of the first single-photon avalanche diode.

The N counting units include a first counting unit, a second counting unit, . . . , and an N^{th} counting unit. Each of the N counting units is connected to a pulse acquisition unit, for example, the first counting unit is connected to the first pulse acquisition unit. Each of the N counting units is configured to determine the number of photons corresponding to the single-photon avalanche diode connected to the pulse acquisition unit connected thereto, for example, the first counting unit is configured to determine the number of photons corresponding to the first single-photon avalanche diode connected to the first pulse acquisition unit, and the number of photons corresponding to the first single-photon avalanche diode is the number of photons hitting the first single-photon avalanche diode. The number of photons determined by the first counting unit, the second counting unit, . . . , and the N^{th} counting unit is summed to determine the total number of photons corresponding to the single-photon avalanche diode array 10. The number of photons corresponding to each single-photon avalanche diode and the total number of photons both refer to the number of photons within a period of time.

The pulse modulation signal is input to the switching power supply 50. The switching power supply 50 outputs a first preset voltage, and the first preset voltage responds to the pulse width modulation signal. Among them, the pulse modulation (Pulse width modulation, PWM) signal, also known as the pulse width modulation signal, is a signal generated by digitally encoding the analog signal level. By adjusting the duty cycle of the pulse width modulation signal, the first preset voltage output by the switching power supply 50 can be adjusted, that is, the supply voltage of the single-photon avalanche diode array 10 can be adjusted.

Please refer to FIG. 3, which is a flow chart of a parameter calibration method provided in an embodiment of the present application. The parameter calibration method is applied to a single-photon avalanche diode array in an electronic device. In some embodiments, the electronic device can be implemented by a structure as shown in FIG. 1-FIG. 2, and the specific implementation process has been described in detail above. As shown in FIG. 3, the parameter calibration method includes the following steps:

Step 301: Obtaining the calibration value of the avalanche breakdown voltage of the single-photon avalanche diode array, the calibration value of the parameters of the single-photon avalanche diode array, and the temperature drift curve of the single-photon avalanche diode array.

Among them, the calibration value of the avalanche breakdown voltage of the single-photon avalanche diode array can be obtained by calibrating the single-photon avalanche diode array through a separately set calibration system, and can also be obtained by calibrating the single-photon avalanche diode array through electronic equipment.

In one embodiment, the process of calibrating the single-photon avalanche diode array by a separately set calibration system to obtain the calibration value of the avalanche breakdown voltage of the single-photon avalanche diode array is as follows: the calibration system includes an optical module, a switching power supply, a temperature control module, a measurement module, a data processing module, and a housing. The single-photon avalanche diode array, the optical module, the switching power supply, the temperature control module, the measurement module, and the data processing module are arranged inside the housing. In one embodiment, the housing is a closed housing. The temperature of the single-photon avalanche diode array is controlled by the temperature control module to be maintained at a calibration temperature or within a calibration temperature range, where the calibration temperature can be set to the same temperature as the ambient temperature (i.e., the temperature inside the housing), or a normal temperature, such as 25° C. In some embodiments, the calibration temperature range can be set to a temperature interval with the ambient temperature as the center point and the left and right endpoints symmetrical relative to the center point, such as [24° C., 26° C.]. At the same time, uniform light is provided by the optical module to configure the light distribution on the surface of the single-photon avalanche diode array to be uniform, and the light intensity gear is weak light. Under the above conditions, the duty cycle of the pulse width modulation signal output by the data processing unit is adjusted to adjust the voltage provided by the switching power supply to the single-photon avalanche diode array (i.e., the voltage input to the single-photon avalanche diode array is adjusted). Then, the measurement module obtains the number of photons within the first preset time corresponding to each voltage input to the single-photon avalanche diode array, and sends it to the data processing module. Among them, the first preset time is a pre-set time, such as 1 minute, 5 minutes, or 10 minutes. Afterwards, the data processing module can determine the calibration value of the avalanche breakdown voltage based on the number of photons within the first preset time corresponding to each voltage input to the single-photon avalanche diode array. For example, the relationship between the number of photons corresponding to each single-photon avalanche diode and the first preset voltage is plotted into a PCR-V curve. N PCR-V curves can be determined based on N single-photon avalanche diodes. A differential operation is performed on each point of each PCR-V curve to determine the voltage corresponding to the point with the largest slope in each PCR-V curve. N voltages are determined based on the N PCR-V curves, and then these N voltages are processed in a preset manner to determine the calibration value of the avalanche breakdown voltage (for example, an average value or a median value is calculated, and the average value or the median value is used as the avalanche breakdown voltage).

The parameters of the single-photon avalanche diode array include dark count and photon detection efficiency. Dark count (DCR) refers to the dark count rate generated by the single-photon avalanche diode array per unit time in the absence of light irradiation (i.e., in the dark state). It can also be understood as the false alarm signal generated by the single-photon avalanche diode array in the dark state. Dark count is usually expressed as the number of dark counts generated per second, in units of Hz. A lower dark count indicates that the single-photon avalanche diode array has better stability in the dark state. Photon detection efficiency (PDE) refers to the detection efficiency of the single-photon avalanche diode array for photons, that is, the ratio of the number of photons actually detected by the single-photon avalanche diode array to the number of incident photons. The photon detection efficiency can reflect the sensitivity and signal-to-noise ratio of the single-photon avalanche diode array.

After determining the calibration value of the avalanche breakdown voltage, the calibration value of the dark count and the calibration value of the photon detection efficiency can be further determined. The process of determining the calibration value of the dark count is: controlling the temperature of the single-photon avalanche diode array to be maintained at the calibration temperature or within the calibration temperature range through the temperature control module, configuring the light distribution on the surface of the single-photon avalanche diode array to be uniform through the optical module, and the light intensity gear is dim, and adjusting the supply voltage of the single-photon avalanche diode array to the calibration value of the avalanche breakdown voltage. Then, the total number of photons y corresponding to the single-photon avalanche diode array 10 within the first preset time length t is counted, and the calibration value of the dark count is y/t.

The process of determining the calibration value of the photon detection efficiency is: controlling the temperature of the single-photon avalanche diode array to be maintained at the calibration temperature or within the calibration temperature range through the temperature control module, and adjusting the supply voltage of the single-photon avalanche diode array to be the calibration value of the avalanche breakdown voltage. Next, the light intensity gears are configured to be dim light, weak light, and relatively strong light in sequence through the optical module, and the total number of photons corresponding to the single-photon avalanche diode array within the first preset time length is counted under each light intensity gear, and the photon detection efficiency is determined based on the total number of photons counted. In some embodiments, the light intensity gear can be divided into three gears based on the number of photons per unit area, for example, dim light, weak light, and relatively strong light, where the dim light corresponds to 0-1 photons, the weak light corresponds to 2-1000 photons, and the relatively strong light corresponds to more than 1000 photons. In other embodiments, the light intensity gears can be divided according to other limiting conditions. In some embodiments, an optical power detector is used to determine the number of photons. Optical power refers to the energy of light radiated by a light source per unit time. An aperture is provided on the optical power detector. Assuming that the optical power detected by the optical power detector is x, the area of the aperture is b, and the energy of each photon is E (corresponding to the laser wavelength), the number of photons per unit area is N=x/(E*b).

The temperature drift curve represents the corresponding relationship between the avalanche breakdown voltage of the single-photon avalanche diode array and the temperature of the single-photon avalanche diode array. In one embodiment, the corresponding relationship between the avalanche breakdown voltage of the single-photon avalanche diode array and the temperature of the single-photon avalanche diode array is shown as curve L1 in FIG. 4, where the abscissa in FIG. 4 is the temperature (in degrees Celsius) and the ordinate is the avalanche breakdown voltage (in volts). In one embodiment, the avalanche breakdown voltage of the single-photon avalanche diode array and the temperature of the single-photon avalanche diode array present a linear relationship, that is, the avalanche breakdown voltage of the single-photon avalanche diode array and the temperature of the single-photon avalanche diode array have a first-order function relationship.

Step 302: According to the calibration value of the avalanche breakdown voltage of the single-photon avalanche diode array, obtaining the temperature of at least two positions in the circumferential direction of the single-photon avalanche diode array.

When the electronic device starts to operate, the temperature of the single-photon avalanche diode array is the calibration temperature or within the calibration temperature range. At this time, the voltage input to the single-photon avalanche diode array is configured to be the calibration value of the avalanche breakdown voltage of the single-photon avalanche diode array. Afterwards, the temperature of at least two positions on the circumference of the single-photon avalanche diode array is obtained in real time to determine whether the heat generated when the electronic device is operating causes the temperature of the single-photon avalanche diode array to exceed the calibration temperature range. When the temperature of the single-photon avalanche diode array is the calibration temperature or within the calibration temperature range, the temperature of at least two positions on the circumference of the single-photon avalanche diode array is also the calibration temperature or within the calibration temperature range. The following description is made by taking the case where the temperature of at least two positions on the circumference of the single-photon avalanche diode array is the calibration temperature when the electronic device starts to operate as an example.

In one embodiment, a temperature sensor is placed at each of at least two positions on the circumference of the single-photon avalanche diode array to detect the temperature of at least two positions on the circumference of the single-photon avalanche diode array. The temperature sensor is a thermistor or a thermocouple. By comprehensively analyzing the temperature measurement results at multiple positions, the impact of single-point failures can be reduced and the reliability and stability of the measurement can be improved.

In some embodiments, at least two positions are symmetrical about the symmetry axis of the single-photon avalanche diode array. The symmetry axis of the single-photon avalanche diode array includes a horizontal symmetry axis and a vertical symmetry axis. In some embodiments, after the single-photon avalanche diode array is bisected along the row direction, a horizontal symmetry axis is obtained, and the horizontal symmetry axis can divide the single-photon avalanche diode array into two parts, including an upper part and a lower part, and the parts on both sides of the symmetry axis completely overlap. In some embodiments, after the single-photon avalanche diode array is bisected along the column direction, a vertical symmetry axis can be obtained, and the vertical symmetry axis divides the single-photon avalanche diode array into two parts, including a left part and a right part, and the parts on both sides of the symmetry axis completely overlap.

The positions corresponding to the detected temperatures are configured to be symmetrical, which can provide a more comprehensive and accurate understanding of the temperature distribution of the entire single-photon avalanche diode array, thereby reducing measurement errors and improving measurement accuracy.

In one embodiment, obtaining the temperature of at least two positions on the circumference of the single-photon avalanche diode array in step 302 includes: obtaining the temperature of four positions on the circumference of the single-photon avalanche diode array, the four positions being four vertices of the single-photon avalanche diode array. The four positions are symmetrical about the symmetry axis of the single-photon avalanche diode array.

In one embodiment, obtaining the temperature of at least two positions on the circumference of the single-photon avalanche diode array in step 302 includes: obtaining the temperature of four positions on the circumference of the single-photon avalanche diode array, the four positions being the midpoints of four sides of the single-photon avalanche diode array. The four positions are symmetrical about the symmetry axis of the single-photon avalanche diode array.

The temperatures at the four positions selected in the above two embodiments can reflect the temperatures in all directions of the single-photon avalanche diode array. The temperature model obtained based on the temperatures at these four positions can more accurately reflect the temperature distribution of the single-photon avalanche diode array.

Step 303: Obtaining a temperature model of the single-photon avalanche diode array according to the temperatures of at least two locations.

Among them, the temperature model represents the correspondence between the temperature and coordinates of the position in the single-photon avalanche diode array.

In some embodiments, when the electronic device starts to operate, the temperatures of at least two locations are both calibrated temperatures. Afterwards, if the absolute value of the difference between any one of the temperatures at the at least two locations and the calibrated temperature is kept smaller than a first preset difference, the voltage input to the single-photon avalanche diode array is kept as a calibrated value of the avalanche breakdown voltage. If the absolute value of the difference between one of the temperatures at the at least two locations and the calibrated temperature is greater than or equal to the first preset difference (caused by the temperature generated during the operation of the electronic device or other reasons), the temperature model of the single-photon avalanche diode array is determined according to the current values of the temperatures at the at least two locations, the avalanche breakdown voltage of the single-photon avalanche diode array is calibrated, and the power supply voltage of the avalanche diode array is adjusted.

Among them, the first preset difference is a value pre-set according to the actual application scenario. In some embodiments, the first preset difference is 0, then as long as one of the temperatures of the at least two locations is not the calibration temperature, the temperature model of the single-photon avalanche diode array is determined according to the current values of the temperatures at the at least two locations, and the avalanche breakdown voltage of the single-photon avalanche diode array is calibrated, thereby having a high sensitivity to maintain the accuracy and reliability of the avalanche breakdown voltage of the single-photon avalanche diode array. In some embodiments, the first preset difference is set to a smaller value greater than 0. If each one of the temperatures of at least two locations fluctuates within a smaller range, the current operating state is kept unchanged (that is, the temperature model is not updated, and the avalanche breakdown voltage and power supply voltage of the single-photon avalanche diode array remain unchanged), which can reduce the operating load of the processor and improve the stability and reliability of the processor. For example, in some embodiments, the first preset difference is set to T1° C., T1 is a smaller value greater than 0, such as 1° C. When each of the temperatures of at least two locations is within the interval [(T0−T1)° C., (T0+T1)° C.], the current operating state is maintained unchanged; otherwise, the temperature model is updated, the avalanche breakdown voltage of the single-photon avalanche diode array is calibrated, and the power supply voltage of the single-photon avalanche diode array is adjusted, where TO is the calibration temperature. That is, when the absolute value of the difference between one of the temperatures of at least two locations and the calibration temperature is greater than 1° C., the temperature model of the single-photon avalanche diode array is determined according to the current values of the temperatures of at least two locations, and the avalanche breakdown voltage of the single-photon avalanche diode array is calibrated, and the power supply voltage of the avalanche diode array is adjusted. In some embodiments, the above interval [(T0−T1)° C., (T0+T1)° C.] is set in the form of percentage, such as [(95% T0° C.), (105% T0)° C.]. For example, if the calibration temperature is 25° C. and the temperature floating range is [(98% T0)° C., (102% T0)° C.], the first preset difference is 0.5° C.

Please refer to FIG. 5, which exemplarily shows a coordinate system established based on a single-photon avalanche diode array. The coordinates of the position in the single-photon avalanche diode array 10 are the coordinates in the coordinate system of the single-photon avalanche diode array 10, the X-axis of the coordinate system extends in the row direction of the single-photon avalanche diode array 10, the Y-axis of the coordinate system extends in the column direction of the single-photon avalanche diode array 10, the unit length of the coordinate system is the size of a single pixel of the single-photon avalanche diode array 10, and the origin O of the coordinate system is the vertex of the single-photon avalanche diode array 10. The size of the single-photon avalanche diode array 10 is X₁*Y₁.

Then, the temperature model of the single-photon avalanche diode array 10 can be determined based on the coordinate system. For example, when the at least two positions include four positions: A1, A2, A3, and A4, which are the four vertices of the single-photon avalanche diode array. Temperature sensors are set at the four positions A1, A2, A3, and A4 to detect the temperatures of the four positions. Positions A1 and A3, and positions A2 and A4, are symmetrical about the vertical symmetry axis of the single-photon avalanche diode array; likewise, positions A1 and A2, and positions A3 and A4, are symmetrical about the horizontal symmetry axis of the single-photon avalanche diode array. The coordinates of A1 are defined as (0, 0), the coordinates of A2 are (0, Y₁, the coordinates of A3 are (X₁, 0), and the coordinates of A4 are (X₁, Y₁.) When the electronic device starts to run, the temperatures of the four positions A1, A2, A3, and A4 are all calibration temperatures, that is, T0° C. During the operation of the electronic device, the temperature at position A1 changes to T2° C., the absolute value of the difference between T2° C. and T0° C. is greater than the first preset difference, and the temperatures at positions A2, A3, and A4 remain at TO. Then, combining the four coordinates (0,0), (0, Y₁), (X₁, 0) and (X₁, Y₁), and the four temperatures of T2° C., T0° C., T0° C., and T0° C., and the size of the single-photon avalanche diode array 10 being X₁*Y₁, the temperature trapezoidal distribution of the single-photon avalanche diode array 10 is fitted through data fitting methods such as linear fitting or polynomial fitting, and then a temperature model of the single-photon avalanche diode array 10 is established.

It should be noted that this embodiment only exemplifies one method of establishing a coordinate system for the single-photon avalanche diode array 10. In other embodiments, other methods may be used to establish a coordinate system. For example, the X-axis and Y-axis of the coordinate system shown in FIG. 5 are interchangeable; for another example, other positions may be selected as the origin.

Secondly, in the above described embodiment, the four positions A1, A2, A3 and A4 are selected as an example. In other embodiments, more or fewer positions can be selected, as well as other positions. For example, as shown in FIG. 6, the temperatures of the four positions A5, A6, A7, and A8 are selected to establish a temperature model, where A5, A6, A7, and A8 are the midpoints of the four sides of the single-photon avalanche diode array. The coordinate system of the position A5 is (0, Y₁/2); the coordinate system of the position A6 is (X₁/2, Y₁); the coordinate system of the position A7 is (X₁, Y₁/2); and the coordinate system of the position A8 is (X₁/2, 0).

Step 304: Determining a calibration value of the avalanche breakdown voltage of the single-photon avalanche diode array according to the temperature model, the temperature drift curve and the calibration values of the parameters of the single-photon avalanche diode array, and adjusting the input voltage of the single-photon avalanche diode array according to the calibration value of the avalanche breakdown voltage of the single-photon avalanche diode array.

Among them, the current value of the parameter of any area in the single-photon avalanche diode array can be determined according to the temperature model and the temperature drift curve, and then based on the current value of the parameter of any area in the single-photon avalanche diode array and the calibration value of the parameter of the single-photon avalanche diode array. It can be determined whether the calibration process of the avalanche breakdown voltage of the single-photon avalanche diode array is completed, and then the calibration value of the avalanche breakdown voltage of the single-photon avalanche diode array can be determined.

As shown in FIG. 7, in one embodiment, the process of determining the calibration value of the avalanche breakdown voltage of the single-photon avalanche diode array according to the temperature model, the temperature drift curve, and the calibration value of the parameters of the single-photon avalanche diode array in step 304 includes the following steps:

Step 701: Determining the current value of the avalanche breakdown voltage of the target area of the single-photon avalanche diode array according to the temperature model and the temperature drift curve.

When the electronic device is in operation and the number of single-photon avalanche diodes included in the single-photon avalanche diode array is large, significant temperature differences may exist among different areas in the single-photon avalanche diode array. In such cases, applying a uniform avalanche breakdown voltage across all areas may compromise the accuracy and reliability of the parameters calibrated by the single-photon avalanche diode array. To address this issue, the single-photon avalanche diode array can be divided into different areas, in which the temperatures at various positions are relatively uniform. For example, the single-photon avalanche diode array is divided into a central area and an edge area, where the central area coincides with the center of the single-photon avalanche diode array, and the edge area is the area of the single-photon avalanche diode array other than the central area. The number of single-photon avalanche diodes included in the central area is equal to the number of single-photon avalanche diodes included in the edge area. Then, corresponding avalanche breakdown voltages may be determined for each respective area, such that the applied breakdown voltage more closely matches the temperature characteristics of that area, thereby improving the accuracy and reliability of the parameters calibrated by the single-photon avalanche diode array.

In some embodiments, as shown in FIG. 8, the process of determining the current value of the avalanche breakdown voltage of the target region of the single-photon avalanche diode array according to the temperature model and the temperature drift curve in step 701 includes the following steps:

Step 801: Obtaining the temperature of the target position according to the temperature model and the coordinates of the target position, where the target position is located in the target area.

Step 802: Obtaining the temperature of the target area according to the temperature of the target position.

Step 803: Determining the current value of the avalanche breakdown voltage of the target area according to the temperature drift curve and the temperature of the target area.

The target area is a pre-set specific area, and the target area can be any area in the single-photon avalanche diode array. In some embodiments, the target area is configured as a region of interest (ROI) in the single-photon avalanche diode array.

In the target area, one or more points that can represent the temperature of the entire target area are selected, and the temperature of the entire target area is determined based on the selected points, where the combination of the selected points is the target position. That is, the target position includes one or more sampling points. When the temperature model is established based on the coordinate system of the single-photon avalanche diode array, each sampling point corresponds to a coordinate in the coordinate system.

The number of sampling points included in the target positions of different target areas may be the same or different. In some embodiments, the single-photon avalanche diode array may be divided into multiple areas based on a preset scheme. For example, the preset restriction scheme is to divide the single-photon avalanche diode array into multiple areas of the same size based on the size of the single-photon avalanche diode array. In another example, the preset scheme is to divide areas with similar temperatures into the same area based on the temperature distribution that may occur in the single-photon avalanche diode array. After the single-photon avalanche diode array is divided into multiple areas, any area can be used as a target area.

In some embodiments, the single-photon avalanche diode array is divided into a central region and an edge region, where the central region is a region whose central point coincides with the central point of the single-photon avalanche diode array and whose area is smaller than the area of the single-photon avalanche diode array. In one embodiment, the central region is a region whose central point coincides with the central point of the single-photon avalanche diode array and whose side lengths are half of the corresponding side lengths of the single-photon avalanche diode array. The edge region is a region other than the central region in the single-photon avalanche diode array. The number of sampling points included in the target position of the central region and the number of sampling points included in the target position of the edge region may be the same or different. In some embodiments, the number of sampling points included in the target position of the central region and the number of sampling points included in the target position of the edge region are both 1. In some embodiments, the number of sampling points included in the target position of the central region is 1, while the number of sampling points included in the target position of the edge region is 2.

The following is an example of dividing the single-photon avalanche diode array 10 into a central area 11 and an edge area 12 as shown in FIG. 9. The central area 11 is an area whose center point coincides with the center point of the single-photon avalanche diode array 10, and whose side lengths are half of the corresponding side lengths of the single-photon avalanche diode array 10. That is, the length of the central area 11 is half of the length of the single-photon avalanche diode array 10. The width of the central area 11 is half of the width of the single-photon avalanche diode array 10. The edge area 12 is the area of the single-photon avalanche diode array 10 other than the central area 11.

In some embodiments, the target area is the central area 11, and the target position includes a sampling point A9. After the temperature model is determined, the coordinates of the sampling point A9 are imported into the temperature model to obtain the temperature of the sampling point A9. The temperature of the sampling point A9 is used as the temperature of the central area 11. Afterwards, the temperature of the central area 11 is substituted into the temperature drift curve shown in FIG. 4 to obtain the corresponding avalanche breakdown voltage, which is the current value of the avalanche breakdown voltage of the central area 11.

In some embodiments, the target area is the edge area 12, and the target position includes two sampling points, A10 and A11. After determining the temperature model, the coordinates of the sampling points A10 and A11 are respectively imported into the temperature model to obtain the temperatures of the sampling points A10 and A11. Then, the temperature of the edge area 12 is determined based on the temperatures of the sampling points A10 and A11. Afterwards, the temperature of the edge area 12 is substituted into the temperature drift curve shown in FIG. 4 to obtain the corresponding avalanche breakdown voltage, which is the current value of the avalanche breakdown voltage of the edge area 12.

In some embodiments, when the target position includes at least two sampling points, the process of obtaining the temperature of the target area according to the temperature of the target position in step 802 includes the following steps: calculating the average value of the temperatures of at least two sampling points, and determining the average value of the temperatures of at least two sampling points as the temperature of the target area. For example, the target position in the edge area 12 includes sampling point A10 and sampling point A11, calculating the average value of the temperatures of sampling point A10 and sampling point A11, and using the average value as the temperature of the edge area 12. In some embodiments, when the target position includes at least two sampling points, the temperature of the target area can also be determined by other means, for example, using the median value of the temperatures of at least two sampling points as the temperature of the target area. In some embodiments, when the target position includes at least two sampling points, the distance between each sampling point and the center point of the single-photon avalanche diode array is used as the weight of the sampling point, and then the temperatures of all sampling points are weighted averaged, and the calculated result is used as the temperature of the target area. Taking the edge area 12 shown in FIG. 9 as an example, the temperature of the sampling point A10 is T10, and the distance between the sampling point A10 and the center point of the single-photon avalanche diode array is S10; the temperature of the sampling point A11 is T11, and the distance between the sampling point A11 and the center point of the single-photon avalanche diode array is S11, then the result of the weighted calculation (i.e., the temperature of the edge area 12) is: (T10*S10+T11*S11)/(S10+S11).

It should be noted that the above description exemplifies a shape of the single-photon avalanche diode array 10, the central area 11, and the edge area 12. In other embodiments, the single-photon avalanche diode array 10, the central area 11, and the edge area 12 may also be other shapes. For example, the central area 11 may also be circular, diamond-shaped, or irregular in shape.

Step 702: Obtaining current values of parameters of the target area according to the current value of the avalanche breakdown voltage of the target area of the single-photon avalanche diode array.

The light intensity gear is configured to be dim light, the voltage input to the target area of the single-photon avalanche diode array is adjusted to be the current value of the avalanche breakdown voltage, and the current value of the dark count is determined based on the total number of photons within the first preset time length corresponding to the target area.

The light intensity levels are configured to be dim light, weak light, and relatively strong light in sequence, and the voltage input to the target area of the single-photon avalanche diode array is adjusted to be the current value of the avalanche breakdown voltage. Based on the total number of photons within the first preset time length corresponding to the target area under each light intensity level, the current value of the photoelectric conversion efficiency is determined.

The process of determining the current value of the dark count and the current value of the photon detection efficiency here is the same as the process of determining the calibration value of the dark count and the calibration value of the photon detection efficiency described before.

Step 703: Determining a calibration value of the avalanche breakdown voltage of the single-photon avalanche diode array according to the current value of the parameter of the target area and the calibration value of the parameter of the single-photon avalanche diode array.

In some embodiments, based on the current value of the parameter of the target region and the calibrated value of the parameter of the single-photon avalanche diode array, it can be determined whether the calibration process of the avalanche breakdown voltage of the target region has been completed.

In one embodiment, when the absolute value of the difference between the current value of the parameter of the target area and the calibrated value of the parameter of the single-photon avalanche diode array is less than a second preset difference, the current value of the avalanche breakdown voltage of the target area is determined as the calibration value of the avalanche breakdown voltage of the target area.

In combination with step 702, the absolute value of the difference between the current value of the parameter of the target area and the calibration value of the parameter of the single-photon avalanche diode array is less than the second preset difference, indicating that when the voltage input to the target area of the photon avalanche diode array is the current value of the avalanche breakdown voltage, the parameter corresponding to the target area has been restored to the normal range. Based on this, the current value of the avalanche breakdown voltage of the target area can be determined as the calibration value of the avalanche breakdown voltage of the target area. Afterwards, the calibration values of the avalanche breakdown voltage of all target areas in the photon avalanche diode array are determined. That is, the determination of the calibration value of the avalanche breakdown voltage of the photon avalanche diode array is completed. For example, in an embodiment in which the photon avalanche diode array is divided into a central area and an edge area, the central area and the edge area are configured as target areas in turn, and the corresponding calibration values of the avalanche breakdown voltage are determined. That is, the determination of the calibration value of the avalanche breakdown voltage of the photon avalanche diode array is completed. In other words, the determination of the calibration value of the avalanche breakdown voltage of the photon avalanche diode array includes the determination of the calibration value of the avalanche breakdown voltage of each region in the single-photon avalanche diode array. The above method enables calibration of the avalanche breakdown voltage of the single-photon avalanche diode array, thereby ensuring the accuracy and stability of the avalanche breakdown voltage of the single-photon avalanche diode array.

The calibration values of the parameters of each region in the single-photon avalanche diode array are all calibration values of the parameters of the single-photon avalanche diode array. That is, the calibration values of the parameters of the target region are the calibration values of the parameters of the single-photon avalanche diode array. In other words, the absolute value of the difference between the current value of the parameter of the target region and the calibration value of the parameter of the single-photon avalanche diode array is less than the second preset difference, and the absolute value of the difference between the current value of the parameter of the corresponding target region and the calibration value of the parameter of the target region is less than the second preset difference.

In the above process of determining the calibration value of the avalanche breakdown voltage of each region in the single-photon avalanche diode array, although the input voltage of the target region in the single-photon avalanche diode array is adjusted, the single-photon avalanche diode array is in a calibration, and does not perform its intended functional operations. For example, in the application scenario where the single-photon avalanche diode array is provided in a LiDAR used to detect the distance from a target object, when the single-photon avalanche diode array is in the calibration state, the LiDAR does not perform distance detection with respect to the target object. After determining the calibration value of the avalanche breakdown voltage of each region in the single-photon avalanche diode array, the calibration value of the avalanche breakdown voltage of the single-photon avalanche diode array is used as the input voltage of the single-photon avalanche diode array, thereby enabling the single-photon avalanche diode array to transition into a functional state. For example, for the above application scenario, after the calibration value of the avalanche breakdown voltage of the single-photon avalanche diode array is used as the input voltage of the single-photon avalanche diode array, the LiDAR can perform the function of distance detection with respect to the target object. Additionally, if the absolute value of the difference between one of the temperatures at the two locations and the calibration temperature is greater than or equal to the first preset difference, step 303 and subsequent steps will be executed again. Thus, the avalanche breakdown voltage that best matches the input of each region in the single-photon avalanche diode array can be maintained, ensuring the accuracy and stability of the receiving parameters.

In some embodiments, the calibration value of the avalanche breakdown voltage of each region in the single-photon avalanche diode array and the temperature of the region corresponding to the calibration value are recorded each time. When the temperature of any region in the single-photon avalanche diode array again reaches the temperature corresponding to any calibration value of the avalanche breakdown voltage corresponding to the region, the calibration value of the avalanche breakdown voltage is directly used to power the region, thereby improving the efficiency of calibration.

The second preset difference is a preset value. In some embodiments, the second preset difference is 0. When the current value of the parameter of the target area is the same as the calibration value of the parameter of the single-photon avalanche diode array, the current value of the avalanche breakdown voltage of the target area is determined as the calibration value of the avalanche breakdown voltage of the target area to ensure the accuracy of the number of photons corresponding to the determined target area. In some embodiments, the second preset value is a smaller value greater than 0. If the current value of the parameter of the target area fluctuates only within a small range, the avalanche breakdown voltage of the target area is not calibrated, reducing the operating load of the processor and improving the stability and reliability of the processor. In some embodiments, the floating interval of the current value of the parameter of the target area is set based on the calibration value of the parameter of the target area, and is implemented in the form of a percentage to determine when the current value of the avalanche breakdown voltage of the target area is determined as the calibration value of the avalanche breakdown voltage of the target area. In some embodiments, 95% of the calibrated value of the parameter of the target area is set as the lower limit value of the floating interval, and 105% of the calibrated value of the parameter of the target area is set as the upper limit value of the floating interval. When the current value of the parameter of the target area is within the floating interval, that is, the absolute value of the difference between the calibrated value of the parameter of the target area and the current value of the parameter of the target area is less than 5% of the calibrated value of the parameter of the target area, the current value of the input avalanche breakdown voltage of the target area is kept unchanged, and the current value of the avalanche breakdown voltage of the target area is determined as the calibration value of the avalanche breakdown voltage of the target area.

In one embodiment, when the absolute value of the difference between the current value of the parameter of the target area and the calibrated value of the parameter of the single-photon avalanche diode array is greater than or equal to a second preset difference, the target area is updated, where the area of the updated target area is smaller than the area of the target area; and a temperature model is obtained based on the temperatures of at least two positions.

Combined with step 702, the absolute value of the difference between the current value of the parameter of the target area and the calibration value of the parameter of the single-photon avalanche diode array is less than the second preset difference, indicating that when the voltage input to the target area of the photon avalanche diode array is the current value of the avalanche breakdown voltage, the number of photons corresponding to the target area has not returned to normal. It can be determined that the area of the target area is large, resulting in a large difference in temperature at different positions in the target area, so that the current value of the avalanche breakdown voltage cannot match all the photon avalanche diodes in the current target area. Based on this, the target area should be updated, and the area of the updated target area should be smaller than the area of the target area. After that, return to execute step 303 and its subsequent steps. Until the absolute value of the difference between the current value of the parameter of the target area and the calibration value of the parameter of the single-photon avalanche diode array is less than the second preset difference, the current value of the avalanche breakdown voltage of the target area is determined as the calibration value of the avalanche breakdown voltage of the target area.

In some embodiments, when returning to step 303, the position corresponding to the detected temperature may be kept unchanged. In this case, since the temperature of at least two positions remains unchanged, the temperature model also remains unchanged. In other embodiments, when returning to step 303, other positions are selected to detect the temperature to update the temperature model.

In the process of returning to execute step 303 and its subsequent steps, when determining the temperature of the target area, the sampling points in the target area can remain unchanged; or other sampling points can be reselected. That is, sampling points of other numbers or other positions can be selected. For example, when executing step 303 and its subsequent steps for the first time, two sampling points are used to determine the temperature of the target area, but because the absolute value of the difference between the current value of the parameter of the target area and the calibration value of the parameter of the single-photon avalanche diode array is greater than or equal to the second preset difference, step 303 and its subsequent steps are executed for the second time. When executing step 303 and its subsequent steps for the second time, another number of sampling points, such as three sampling points, are sampled to determine the temperature of the target area.

Please refer to FIG. 10, which is a flow chart of a parameter calibration method provided by an embodiment of the present application. As shown in FIG. 10, first, obtain the calibration value of the avalanche breakdown voltage of the single-photon avalanche diode array, the calibration value of the parameter of the single-photon avalanche diode array, and the temperature drift curve of the single-photon avalanche diode array. Then, configure the voltage input to the single-photon avalanche diode array as the calibration value of the avalanche breakdown voltage of the single-photon avalanche diode array, and obtain the temperature of at least two positions on the circumference of the single-photon avalanche diode array. If the absolute value of the difference between the temperature of at least two positions and the calibration temperature is less than the first preset difference, then keep configuring the voltage input to the single-photon avalanche diode array as the calibration value of the avalanche breakdown voltage of the single-photon avalanche diode array. If the absolute value of the difference between the temperature of one of the at least two positions and the calibration temperature is greater than or equal to the first preset difference, then obtain the temperature model of the single-photon avalanche diode array according to the temperature of at least two positions. After obtaining the temperature model, the coordinates of the target position are imported into the temperature model to obtain the temperature of the target position, and the temperature of the target area is obtained according to the temperature of the target position. Then the temperature of the target area is imported into the temperature drift curve to obtain the current value of the avalanche breakdown voltage of the target area. After that, the voltage input to the target area is configured as the current value of the avalanche breakdown voltage of the target area, and the current value of the parameter of the target area can be obtained. If the absolute value of the difference between the current value of the parameter of the target area and the calibration value of the parameter of the target area is less than the second preset difference, it is considered that the adjustment process of the avalanche breakdown voltage for the target area has been completed. In this case, the voltage input to the target area is kept as the current value of the avalanche breakdown voltage of the target area. On the contrary, if the absolute value of the difference between the current value of the parameter of the target area and the calibration value of the parameter of the target area is greater than or equal to the second preset difference, it is considered that the adjustment process of the avalanche breakdown voltage for the target area is not completed. In this case, the area of the target area is first updated so that the area of the updated target area is smaller than the original area, that is, the area of the target area is reduced. Then, the step of obtaining the temperature model of the single-photon avalanche diode array according to the temperatures of at least two positions and subsequent steps are returned to be executed again until the absolute value of the difference between the current value of the parameter of the target area and the calibrated value of the parameter of the target area is greater than or equal to the second preset difference.

At this stage, real-time calibration of the avalanche breakdown voltage of the target area in the single-photon avalanche diode array is achieved. By sequentially configuring each area in the single-photon avalanche diode array as the target area, real-time calibration of the avalanche breakdown voltage of the entire single-photon avalanche diode array can be achieved, ensuring the accuracy and stability of the receiving parameters of the single-photon avalanche diode array.

An embodiment of the present application also provides a non-volatile computer-readable storage medium, which stores computer-executable instructions, and the computer-executable instructions are executed by one or more processors, for example, to execute the method steps as shown in FIGS. 3, 7, 8, and 10 and described above.

The above description is provided merely as exemplary embodiments of the present application and is not intended to limit the scope of the present application. Any equivalent structure or equivalent process transformation made using the contents of the present application specification and drawings, or directly or indirectly applied in other related technical fields, are included in the protection scope of the present application.

The foregoing embodiments are provided solely for the purpose of illustrating the technical solutions of the present application and are not intended to limit the scope thereof. Within the scope and spirit of the present application, the technical features described in the above embodiments, or in different embodiments, may be combined in various ways, and the steps recited may be performed in any suitable order. It will be understood by those skilled in the art that the technical solutions described in the above embodiments may be subject to modifications or that certain technical features may be replaced with their equivalents. Such modifications or substitutions shall not be construed as departing from the essence or scope of the technical solutions disclosed in the embodiments of the present application.

What is claimed is:

1. A method of parameter calibration, applied to a single-photon avalanche diode array in an electronic device, comprising:
obtaining a calibration value of an avalanche breakdown voltage of the single-photon avalanche diode array, calibration values of parameters of the single-photon avalanche diode array, and a temperature drift curve of the single-photon avalanche diode array, wherein the parameters comprises dark counts and photon detection efficiency, and the temperature drift curve represents a corresponding relationship between the avalanche breakdown voltage of the single-photon avalanche diode array and a temperature of the single-photon avalanche diode array;
obtaining temperatures of at least two positions in a circumferential direction of the single-photon avalanche diode array according to the calibration value of the avalanche breakdown voltage of the single-photon avalanche diode array;
obtaining a temperature model of the single-photon avalanche diode array according to the temperatures of the at least two positions, wherein the temperature model represents a corresponding relationship between the temperature and coordinates of the positions in the single-photon avalanche diode array; and
determining a calibration value of the avalanche breakdown voltage of the single-photon avalanche diode array according to the temperature model, the temperature drift curve, and the calibration values of the parameters of the single-photon avalanche diode array, and adjusting an input voltage of the single-photon avalanche diode array according to the calibration value of the avalanche breakdown voltage of the single-photon avalanche diode array.

2. The method according to claim 1, wherein determining the calibration value of the avalanche breakdown voltage of the single-photon avalanche diode array according to the temperature model, the temperature drift curve, and the calibration values of the parameters of the single-photon avalanche diode array comprises:
determining a current value of an avalanche breakdown voltage of a target region of the single-photon avalanche diode array according to the temperature model and the temperature drift curve;
obtaining the current value of the parameter of a target area according to the current value of the avalanche breakdown voltage of the target area of the single-photon avalanche diode array; and
determining the calibration value of the avalanche breakdown voltage of the single-photon avalanche diode array according to the current value of the parameter of the target area and the calibrated value of the parameter of the single-photon avalanche diode array.

3. The method according to claim 2, wherein determining the current value of the avalanche breakdown voltage of the target region of the single-photon avalanche diode array according to the temperature model and the temperature drift curve comprises:
obtaining a temperature of the target position according to the temperature model and the coordinates of the target position, wherein the target position is located in the target area;
obtaining the temperature of the target area according to the temperature of the target position; and
determining the current value of the avalanche breakdown voltage of the target area according to the temperature drift curve and the temperature of the target area.

4. The method according to claim 2, wherein determining the calibration value of the avalanche breakdown voltage of the single-photon avalanche diode array according to the current value of the parameter of the target area and the calibrated value of the parameter of the single-photon avalanche diode array comprises:
determining the current value of the avalanche breakdown voltage of the target region as the calibrated value of the avalanche breakdown voltage of the target region.

5. The method according to claim 2, wherein determining the calibration value of the avalanche breakdown voltage of the single-photon avalanche diode array according to the current value of the parameter of the target area and the calibrated value of the parameter of the single-photon avalanche diode array comprises:
updating the target region, wherein an area of the updated target region is smaller than an area of the target region; and
obtaining the temperature model according to the temperatures of the at least two positions.

6. The method according to claim 3, wherein the target position includes at least two sampling points,
wherein obtaining the temperature of the target area according to the temperature of the target position comprises:
calculating an average value of the temperatures of the at least two sampling points, and determining the average value of the temperatures of the at least two sampling points as the temperature of the target area.

7. The method according to claim 1, wherein the coordinates of the position in the single-photon avalanche diode array are the coordinates in a coordinate system of the single-photon avalanche diode array, an X-axis extension direction of the coordinate system is a row direction of the single-photon avalanche diode array, a Y-axis extension direction of the coordinate system is a column direction of the single-photon avalanche diode array, a unit length of the coordinate system is a size of a single pixel of the single-photon avalanche diode array, and an origin of the coordinate system is a vertex of the single-photon avalanche diode array.

8. The method according to claim 1, wherein the at least two positions are symmetrical about a symmetry axis of the single-photon avalanche diode array.

9. An electronic device, comprising:
a single-photon avalanche diode array;
a memory for storing executable program codes; and
a processor, configured to call and run the executable program codes from the memory, such that the electronic device executes operations comprising:
obtaining a calibration value of an avalanche breakdown voltage of a single-photon avalanche diode array, calibration values of parameters of the single-photon avalanche diode array, and a temperature drift curve of the single-photon avalanche diode array, wherein the parameters comprises dark counts and photon detection efficiency, and the temperature drift curve represents a corresponding relationship between the avalanche breakdown voltage of the single-photon avalanche diode array and the temperature of the single-photon avalanche diode array;
obtaining temperatures of at least two positions in a circumferential direction of the single-photon avalanche diode array according to the calibration value of the avalanche breakdown voltage of the single-photon avalanche diode array;
obtaining a temperature model of the single-photon avalanche diode array according to the temperatures of the at least two positions, wherein the temperature model represents a corresponding relationship between the temperature and coordinates of the positions in the single-photon avalanche diode array; and
determining a calibration value of the avalanche breakdown voltage of the single-photon avalanche diode array according to the temperature model, the temperature drift curve, and the calibration values of the parameters of the single-photon avalanche diode array, and adjusting an input voltage of the single-photon avalanche diode array according to the calibration value of the avalanche breakdown voltage of the single-photon avalanche diode array.

10. A non-transitory computer-readable storage medium storing a computer program, wherein when the computer program is executed, cause a processor to perform operations comprising:
obtaining a calibration value of an avalanche breakdown voltage of a single-photon avalanche diode array, calibration values of parameters of the single-photon avalanche diode array, and a temperature drift curve of the single-photon avalanche diode array, wherein the parameters comprises dark counts and photon detection efficiency, and the temperature drift curve represents a corresponding relationship between the avalanche breakdown voltage of the single-photon avalanche diode array and the temperature of the single-photon avalanche diode array;
obtaining temperatures of at least two positions in a circumferential direction of the single-photon avalanche diode array according to the calibration value of the avalanche breakdown voltage of the single-photon avalanche diode array;
obtaining a temperature model of the single-photon avalanche diode array according to the temperatures of the at least two positions, wherein the temperature model represents a corresponding relationship between the temperature and coordinates of the positions in the single-photon avalanche diode array; and
determining a calibration value of the avalanche breakdown voltage of the single-photon avalanche diode array according to the temperature model, the temperature drift curve, and the calibration values of the parameters of the single-photon avalanche diode array, and adjusting an input voltage of the single-photon avalanche diode array according to the calibration value of the avalanche breakdown voltage of the single-photon avalanche diode array.
